(19) United States
(12) Patent Application Publication
(10) Pub. No.: US 2005/0163194 A1
(43) Pub. Date: Jul. 28, 2005

(54) Interference estimation in a wireless communication system

(75) Inventors: Dhananjay Ashok Gore, San Diego, CA (US); Avneesh Agrawal, San Diego, CA (US); Arvind Vijay Keerthi, San Diego, CA (US)

Correspondence Address: Qualcomm Incorporated;Patents Department, 5775 Morehouse Drive, San Diego, CA, 92121-1714, US

(73) Assignee: QUALCOMM Incorporated

(21) Appl. No.: 11/022,489

(22) Filed: Dec. 22, 2004

Related U.S. Application Data
(60) Provisional application No. 60/540,311, filed on Jan. 28, 2004.

(51) Int. Cl. H04B 1/713

(52) U.S. Cl. 375/132

(57) ABSTRACT

Interference may be controlled by selectively blanking or attenuating transmit powers. A method of estimating interference caused by a transmitting entity in a wireless communication system comprises determining a desired level of accuracy in an interference estimate, determining a required number of blanks per subband set to achieve the desired level of accuracy, inserting the required number of blanks per subband set into a frequency hopping (FH) sequence, and transmitting according to the FH sequence.

### CLAIM OF PRIORITY UNDER 35 U.S.C. §119

The present Application for patent claims priority to Provisional Application No. 60/540,311 entitled “PILOT DESIGN FOR INTERFERENCE ESTIMATION IN OFDMA,” filed Jan. 28, 2004, and assigned to the assignee hereof and hereby expressly incorporated by reference herein.

### REFERENCE TO CO-PENDING APPLICATIONS FOR PATENT

The present Application for patent is related to the following co-pending U.S. patent application:

“Interference Control Via Selective Blanking/Attenuation Of Interfering Transmissions,” filed May 17, 2004, patent application Ser. No. 10/848,023, assigned to the assignee hereof, and expressly incorporated by reference herein.

### BACKGROUND

I. Field

The present invention relates generally to wireless communications, and more specifically to interference estimation in wireless communication system.

II. Background

Orthogonal frequency division multiplexing (OFDM) system is a multi-carrier modulation technique that effectively partitions the overall system bandwidth into multiple (NF) orthogonal subbands. These subbands are also referred to as tones, subcarriers, bins, and frequency channels. With OFDM, each subband is associated with a respective subcarrier that may be modulated with data. Up to NF modulation symbols may be transmitted on the NF subbands in each OFDM symbol period. Prior to transmission, these modulation symbols are transformed to the time-domain using an NF-point inverse fast Fourier transform (IFFT) to obtain a “transformed” symbol that contains NF chips.

In a frequency hopping (FH) communication system, data is transmitted on different frequency subbands in different time intervals, which may be called “hop periods”. These subbands may be provided by OFDM, other multi-carrier modulation techniques, or some other constructs. With frequency hopping, the data transmission hops from subband to subband in a pseudo-random manner. This hopping provides frequency diversity and allows the data transmission to better withstand deleterious path effects such as narrow-band interference, jamming, fading, and so on.

With block hopping, a block of data transmissions hop from a block of subbands to another block of subbands. Each block comprises contiguous subbands.

An orthogonal frequency division multiple access (OFDMA) system utilizes OFDM and can support multiple users. For a frequency hopping OFDMA (FH-OFDMA) system, each user may be assigned a specific FH sequence that indicates the specific subband(s) to use for data transmission in each hop period. Multiple data transmissions for multiple users may be sent simultaneously using different FH sequences that are orthogonal to one another, so that only one data transmission uses each subband in each hop period. Using orthogonal FH sequences, the multiple data transmissions do not interfere with one another while enjoying the benefits of frequency diversity.

An FH-OFDMA system typically includes many sectors, where the term “sector” can refer to a base transceiver subsystem (BTS) and/or the coverage area of the BTS, depending on the context in which the term is used. Data transmissions for users communicating with the same sector may be sent using orthogonal FH sequences to avoid “intra-sector” interference, as described above. However, data transmissions for users in different sectors are typically not orthogonalized. Each user thus observes “inter-sector” interference from users in other sectors. The detrimental effects of inter-sector interference may be reduced by defining the FH sequences for each sector to be pseudo-random or independent with respect to the FH sequences for nearby sectors. The use of pseudo-random FH sequences randomizes inter-sector interference so that each user observes the average interference from users in other sectors. However, the randomized inter-sector interference may still significantly degrade performance for some disadvantaged users observing high levels of interference.

In addition to randomized inter-sector interference, the channel distorts the transmitted signal. In a wireless communication system, a transmitter typically encodes, interleaves, and modulates (i.e., symbol maps) traffic data to obtain data symbols, which are modulation symbols for data. For a coherent system, the transmitter multiplexes pilot symbols with the data symbols, processes the multiplexed pilot and data symbols to generate a modulated signal, and transmits the signal via a wireless channel. The channel distorts the transmitted signal with a channel response and further degrades the signal with noise and interference.

A receiver receives the transmitted signal and processes the received signal to obtain received symbols. For a coherent system, the receiver typically estimates the channel response with the received pilot symbols and performs coherent demodulation/detection of the received data symbols with the channel response estimates to obtain recovered data symbols, which are estimates of the data symbols transmitted by the transmitter. The receiver then symbol demaps, deinterleaves, and decodes the recovered data symbols to obtain decoded data, which is an estimate of the traffic data sent by the transmitter.

In a typical coherent wireless system, the receiver processes the received pilot symbols once to obtain the channel response estimates and also performs coherent demodulation once on the received data symbols to obtain the recovered data symbols. The receiver then performs symbol demapping, deinterleaving, and decoding on the recovered symbols in accordance with the coding and modulation schemes used for the traffic data. The noise and interference degrade the quality of the recovered data symbols and affect the reliability of the decoded data.

Estimating interference enables recovering symbols and aids the reliability of the decoded data. There is therefore a need in the art for techniques that aid interference estimation in a wireless communication system.

### SUMMARY

Techniques for pilot transmission and interference estimation may be used for various wireless communication systems and for the reverse link as well as the forward link. Interference may be estimated by turning off (i.e., blanking) or reducing (i.e., attenuating) transmit powers for interfering users.

In an aspect, a method of estimating interference caused by a transmitting entity in a wireless communication system, comprises determining a desired level of accuracy in an interference estimate, and determining a required number of blanks per subband set to achieve the desired level of accuracy. In an aspect, the method further comprising inserting the required number of blanks per subband set into a frequency hopping (FH) sequence. In yet another aspect, the method further comprises transmitting according to the FH sequence.

In an aspect, an apparatus operable to estimate interference in a wireless communication system comprises a controller operative to create a fast hopping (FH) sequence including a required number of blanks per subband set, and a unit operative to turn off or reduce transmit power for transmissions sent on a plurality of transmission spans according to the FH sequence.

In another aspect, an apparatus operable to estimate interference in a wireless communication system comprises means for determining desired level of accuracy in an interference estimate, and means for determining required number of blanks per subband set to achieve the desired level of accuracy. In yet another aspect, the apparatus further comprising means for transmitting according to the FH sequence.

In an aspect, a computer readable media embodying a method for estimating interference caused by a transmitting entity in a wireless communication system, the method comprises determining a desired level of accuracy in an interference estimate, and determining a required number of blanks per subband set to achieve the desired level of accuracy.

In yet another aspect, a processor programmed to execute a method of estimating interference in a wireless communication system, the method comprises determining a desired level of accuracy in an interference estimate, and determining a required number of blanks per subband set to achieve the desired level of accuracy.

Various aspects and embodiments of the invention are described in further detail below.

### BRIEF DESCRIPTION OF THE DRAWINGS

The features and nature of the present invention will become more apparent from the detailed description set forth below when taken in conjunction with the drawings in which like reference characters identify correspondingly throughout and wherein:

FIG. 1 shows a wireless multiple-access communication system;

FIG. 2 illustrates frequency hopping on a time-frequency plane;

FIG. 3 shows block hopping with a dedicated pilot in accordance with an embodiment;

FIG. 4 shows block hopping with a common pilot in accordance with an embodiment;

FIG. 5 shows a serving base station and an interfering base station in accordance with an embodiment; and

FIG. 6 shows a wireless terminal in accordance with an embodiment.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

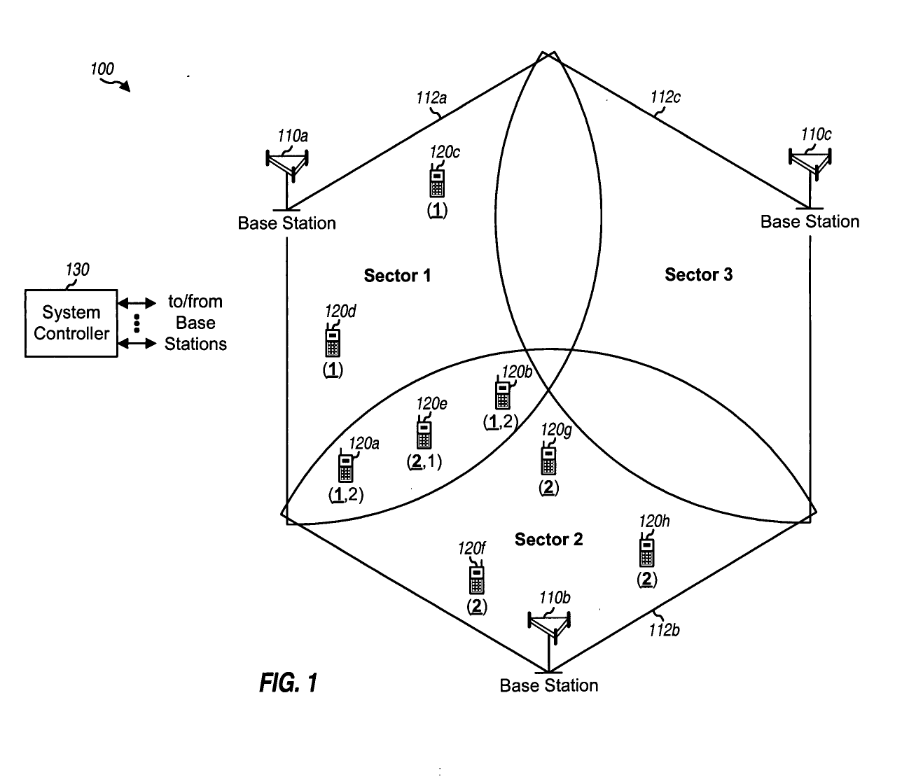

FIG. 1 shows a wireless multiple-access communication system 100. System 100 includes a number of base stations 110 that support communication for a number of wireless terminals 120. A base station is a fixed station used for communicating with the terminals and may also be referred to as an access point, a Node B, or some other terminology. Terminals 120 are typically dispersed throughout the system, and each terminal may be fixed or mobile. A terminal may also be referred to as a mobile station, a user equipment (UE), a wireless communication device, or some other terminology. Each terminal may communicate with one or possibly multiple base stations on the forward and reverse links at any given moment. The forward link (or downlink) refers to the communication link from the base stations to the terminals, and the reverse link (or uplink) refers to the communication link from the terminals to the base stations. A system controller 130 couples to base stations 110, provides coordination and control for these base stations, and further controls the routing of data for the terminals served by these base stations.

Each base station 110 provides communication coverage for a respective geographic area. A base station and/or its coverage area may be referred to as a “cell”, depending on the context in which the term is used. To increase capacity, the coverage area of each base station may be partitioned into multiple (e.g., three) sectors 112. Each sector is served by a BTS. For a sectorized cell, the base station for that cell typically includes the BTSs for all sectors of that cell. For simplicity, in the following description, the term “base station” is used generically for both a fixed station that serves a cell and a fixed station that serves a sector. A “serving” base station or “serving” sector is one with which a terminal communicates. The terms “user” and “terminal” are also used interchangeably herein.

Interference estimation techniques described herein may be used for various wireless communication systems. For example, these techniques may be used for an OFDMA system, a Time Division Multiple Access (TDMA) system, a Frequency Division Multiple Access (FDMA) system, and so on. A TDMA system uses time division multiplexing (TDM), and transmissions for different terminals are orthogonalized by transmitting in different time intervals. An FDMA system uses frequency division multiplexing (FDM), and transmissions for different terminals are orthogonalized by transmitting in different frequency subbands. An OFDMA system utilizes OFDM, which effectively partitions the overall system bandwidth into a number of (N) orthogonal frequency subbands. These subbands are also referred to as tones, sub-carriers, bins, frequency channels, and so on. Each subband is associated with a respective sub-carrier that may be modulated with data. An OFDMA system may use any combination of time, frequency, and/or code division multiplexing.

Interference estimation techniques may be used for the forward link as well as the reverse link. For clarity, these techniques are described below for the forward link in an FH-OFDMA system. For this FH-OFDMA system, multiple “traffic” channels may be defined whereby (1) each subband is used for only one traffic channel in any given hop period and (2) each traffic channel may be assigned zero, one, or multiple subbands in each hop period.

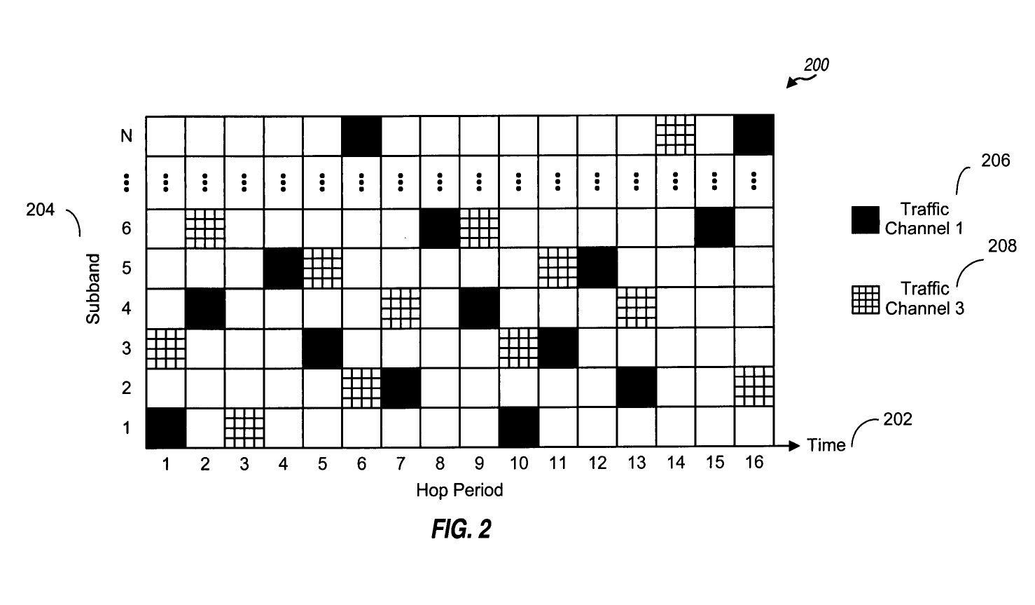

FIG. 2 illustrates frequency hopping on a time-frequency plane 200 for an FH-OFDMA system in accordance with an embodiment. The horizontal axis 202 is time. The vertical axis 204 is subband. Hopping for a traffic channel 1 206 and a traffic channel 3 208 is shown.

With frequency hopping, each traffic channel is associated with a specific FH sequence that indicates the particular subband(s) to use for that traffic channel in each hop period. The FH sequences for different traffic channels in each sector are orthogonal to one another so that no two traffic channels use the same subband in any given hop period. The FH sequences for each sector are also pseudo-random with respect to the FH sequences for nearby sectors. These properties minimize intra-sector interference and randomize inter-sector interference. Interference between two traffic channels in two sectors occurs whenever these traffic channels use the same subband in the same hop period. However, the inter-sector interference is randomized due to the pseudo-random nature of the FH sequences used for different sectors.

Although frequency hopping can randomize inter-sector interference over a data transmission, the interference may still be high and may significantly degrade performance for some users. For example, users located at the edge of their sectors (e.g., terminals 120a, 120b and 120e in FIG. 1) typically receive their data transmissions at low power levels because they are farther away from their serving base stations. Furthermore, these sector-edge users may also receive higher levels of interference because they are located closer to interfering base stations. The interference may be bursty, and large amounts of interference may occur whenever the FH sequences for users in neighboring sectors collide with the FH sequences for the sector-edge users.

The techniques described herein can control interference for target users due to interfering users in other sectors. In general, a target user is one for which reduced inter-sector interference is sought. An interfering user is one deemed to be interfering with a target user. The target and interfering users are in different sectors with the frequency hopping described above. The target and interfering users as well as interfering sectors may be identified as described below. Interference may be controlled in various manners.

In other words, the estimated interference is a Chi-squared random variable with the distribution

$$f ( {\hat{σ}}_{I}^{2} ) = \frac{{( {N}_{B} / {σ}_{I}^{2} )}^{{N}_{N}}}{{N}_{B} !} {x}^{{N}_{B} - 1} {ⅇ}^{- {N}_{B} x / {σ}_{I}^{2}}$$

with mean equal to the true variance (σ_{I}²) and variance equal to (σ_{I}²/N_{B}).

This estimator has the property that the standard deviation of the error distribution

$$( 10 {log}_{10} ( \frac{{\hat{σ}}_{I}^{2}}{{σ}_{I}^{2}} ) ) ,$$

is independent of the received signal energy, underlying distribution of the interference (e.g., Log Normal) and channel estimation error.

Table 1 indicates the required number of blanks to achieve a desired level of accuracy in the interference estimate in accordance with an embodiment. Table 1 shows the standard deviation of error distribution versus the number of blanks. The underlying distribution is a log normal with 6.15 dB standard deviation.

TABLE 1

| | | | | | | |
|---|---|---|---|---|---|---|
| N_{B} | 1 | 2 | 3 | 4 | 5 | 10 |
| $std ( 10 {log}_{10} [ {\hat{σ}}_{I}^{2} / {σ}_{I}^{2} ] )$ | 3.47 | 2.78 | 2.33 | 2.05 | 1.89 | 1.41 |

In an embodiment for estimating interference, the transmit powers are selectively blanked or attenuated. Each user in each neighboring sector would receive either no transmission or transmission with reduced power on each subband in the blanking pattern for that sector. If blanking is performed, then each neighboring user would experience randomized puncturing of data symbols that are not transmitted on the subbands in the blanking pattern. The puncturing rate is determined by the rate at which the FH sequence for an interfering user collides with the FH sequence for the target user. The puncturing rate should be relatively low so that neighboring users experience negligible degradation in performance. If attenuation is performed, then each neighboring user would receive lower energy symbols on the subbands in the blanking pattern, due to the use of lower transmit powers for these subbands. However, these received symbols still contain useful information and are helpful for decoding.

In an embodiment, each user maintains an “active set” that contains all sectors that are candidates for serving the user. Each user may receive pilots from various sectors, measure the received pilot power for each sector, and add a sector in the active set if the received pilot power for the sector exceeds a predetermined add threshold.

In an embodiment, each user communicates with only one sector in the active set at any given time, which is called the serving sector. In an alternative embodiment, a user can communicate with more than one sector in the active set at any given time.

In an embodiment, each user may (e.g., continually or periodically) measure the pilots from the sectors in the active set and may select one sector to designate as the serving sector based on the pilot measurements. Each user may also (e.g., periodically) search for pilots from other sectors, measure these pilots, and determine whether or not to update/change the sectors in the active set. Each user may provide its active set to its serving sector, for example, at the start of a call and whenever the active set changes. Each sector would then have the active set information for each user in communication with that sector.

Referring back to FIG. 1, eight users a through h for terminals 120a through 120h, respectively, are shown distributed throughout sectors 1 and 2. The active set for each user is shown within parenthesis, with the serving sector being indicated by bold and underlined text and the non-serving sector (if any) by normal text. Sector 1 is the serving sector for users a, b, c and d, and sector 2 is the serving sector for users e, f, g and h.

An example of a system and method for blanking time slots and frequency ranges can be found in U.S. patent application Ser. No. 10/848,023 entitled, “Interference Control Via Selective Blanking/Attenuation Of Interfering Transmissions,” filed May 17, 2004, and assigned to the assignee hereof, and expressly incorporated by reference herein.

Associating carriers in the forward link implies that carriers hop in groups. If these groups are all adjacent then all associated carriers experience the same interference variance within a hop. Given that a certain number (N_{B}) of blank pilots, per set of associated carriers per hop, is essential for good interference estimation and that introducing blank pilots increases bandwidth inefficiency, increasing subcarrier association reduces the bandwidth loss. The disadvantage of this scheme of course is that it reduces frequency diversity, especially for packet formats with small number of carriers. This loss is expected to decrease with increasing number of transmissions.

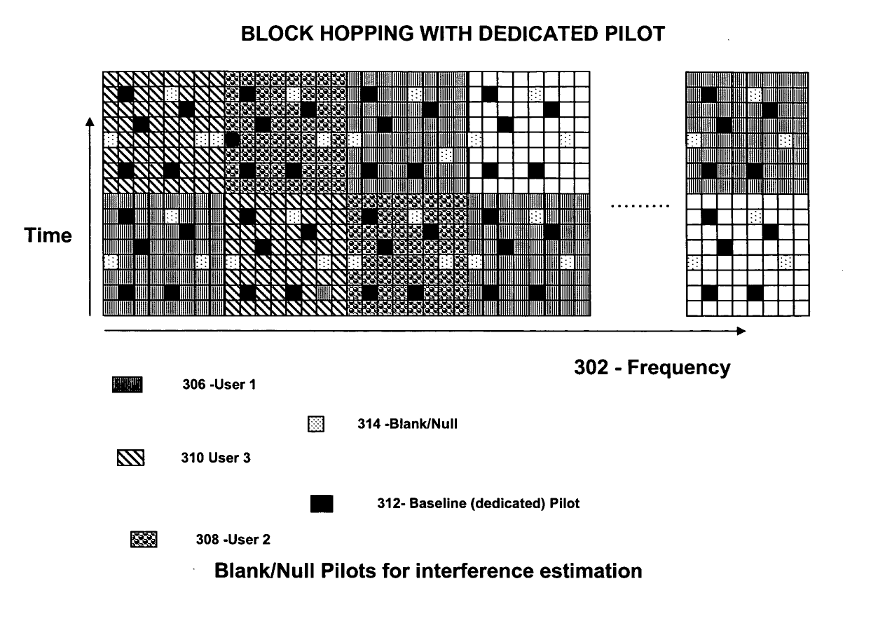

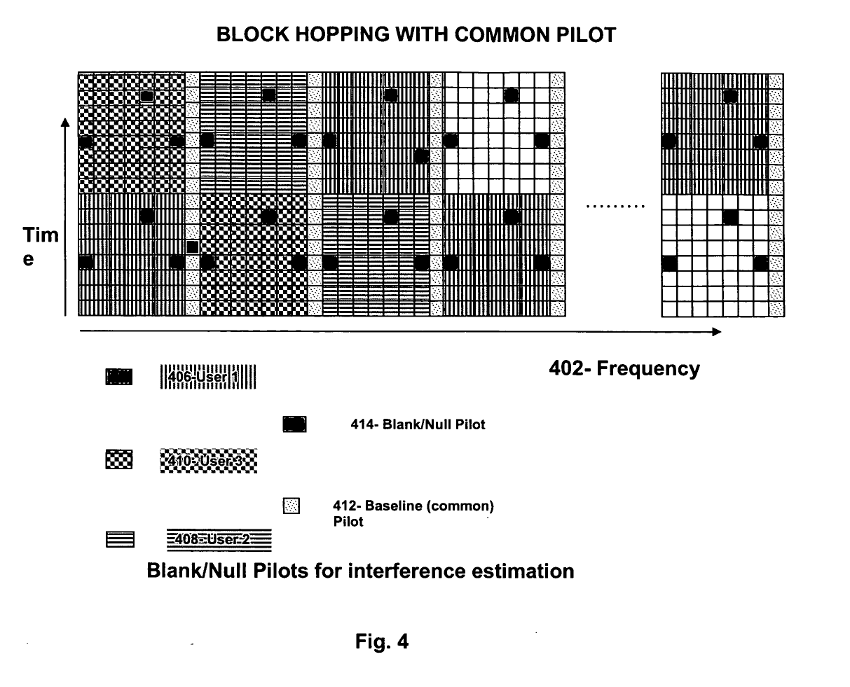

FIGS. 3 and 4 depict the use of Blank/Null pilots for interference estimation in accordance with an embodiment. FIG. 3 shows block hopping with a dedicated pilot in accordance with an embodiment. FIG. 4 shows block hopping with a common pilot in accordance with an embodiment.

FIG. 3 depicts block hopping where a number of adjacent subcarriers are allocated to a user. The horizontal axis 302 is frequency. The vertical axis 304 is time. Three users are shown: User 1 306, User 2 308, and User 3 310.

Channel estimation is performed using dedicated pilots 312, i.e., some of the assigned symbols are utilized as pilot symbols. It is assumed that the pilots corresponding to a particular user cannot be utilized by another user. Interference estimation may also be performed using these dedicated pilots. If these dedicated pilots are inadequate, then additional blank/null pilots 314 may be introduced to aid the interference estimation.

FIG. 4 depicts block hopping with a common (broadcast) pilot 412 is used by all users for channel estimation. The horizontal axis 402 is frequency. The vertical axis 404 is time. Three users are shown: User 1 406, User 2 408, and User 3 410.

Since the common pilot does not experience the same interference as data, additional pilots are necessary for purposes of interference estimation. Blank/null pilots 414 are introduced for the purpose of interference estimation.

In an embodiment, blank pilots are transmitted on the forward link for the purpose of interference estimation. “Blank” symbols are introduced in the forward link transmission so that the user can use the observations of the blank symbols to estimate interference variance. Such blanking leads to a bandwidth loss but not necessarily a power loss since the power can be redistributed across the remaining data symbols. The number of information bits is adjusted so that even after introducing the blank pilots the code rate is the same as that without blank pilots. The total loss can be accounted for as bandwidth inefficiency.

Inserting blank pilots for interference estimation is robust to effects such as channel estimation error, SNR, and the underlying interference distribution, at least in terms of the error distribution.

Assume that in any one hop for a given set of associated carriers (all of which experience the same interference variance), there are N_{B} number of blank pilots available to estimate the interference. Since there is no signal transmitted on these blank pilots, the interference may be directly estimated as

$${\hat{σ}}_{I}^{2} = \frac{1}{{N}_{B}} {\sum }_{i = 1}^{{N}_{B}} {\vert {n}_{i} \vert}^{2} , {n}_{i} \sim CN ( 0 , {σ}_{I}^{2} ) ,$$

where,

σ_{I}^{\hat{ }2} is the interference estimate,

N_{B} is the number of blank pilots, and

nᵢ is the observation on the i^{th} blank pilot.

In other words, the estimated interference is a Chi-squared random variable with the distribution

$$f ( {\hat{σ}}_{I}^{2} ) = \frac{{( {N}_{B} / {σ}_{I}^{2} )}^{{N}_{N}}}{{N}_{B} !} {x}^{{N}_{B} - 1} {ⅇ}^{- {N}_{B} x / {σ}_{I}^{2}}$$

with mean equal to the true variance (σ_{I}²) and variance equal to (σ_{I}²/N_{B}).

This estimator has the property that the standard deviation of the error distribution,

$$( 10 {log}_{10} ( \frac{{\hat{σ}}_{I}^{2}}{{σ}_{I}^{2}} ) ) ,$$

is independent of the received signal energy, underlying distribution of the interference (e.g., Log Normal) and channel estimation error.

Table 1 indicates the required number of blanks to achieve a desired level of accuracy in the interference estimate in accordance with an embodiment. Table 1 shows the standard deviation of error distribution versus the number of blanks. The underlying distribution is a log normal with 6.15 dB standard deviation.

TABLE 2

| | | | | | | |
|---|---|---|---|---|---|---|
| N_{B} | 1 | 2 | 3 | 4 | 5 | 10 |
| $std ( 10 {log}_{10} [ {\hat{σ}}_{I}^{2} / {σ}_{I}^{2} ] )$ | 3.47 | 2.78 | 2.33 | 2.05 | 1.89 | 1.41 |

In an embodiment, the number of blanks to be inserted is based on the desired standard deviation of error distribution. The more the number of blanks, the less the standard deviation of error distribution.

It would be apparent to those skilled in the art that there are numerous algorithms to determine which time slots and frequency ranges to blank. Any algorithm known in the art for determining which time slots and frequency ranges to blank may be used.

It would be apparent to those skilled in the art that in an embodiment, blanks may be punctured into a transmission sequence (also called an FH sequence in the case of a frequency hopping system), whereas in another embodiment, blanks may not be punctured into a transmission sequence. Whether or not blanks may be punctured into a transmission sequence depends on transceiver design and/or application.

An example of a system and method for blanking time slots and frequency ranges can be found in U.S. patent application Ser. No. 10/848,023 entitled, “Interference Control Via Selective Blanking/Attenuation Of Interfering Transmissions,” filed May 17, 2004, and assigned to the assignee hereof, and expressly incorporated by reference herein.

Referring back to FIG. 1, sector 1 may have difficulty transmitting to user a and b. In this example, all non-serving sectors in a target user's active set are deemed to be interfering sectors. Since users a and b both have sector 2 as the only non-serving sector in their active sets, sector 1 informs sector 2 of the difficulty in transmitting to users a and b and provides the FH sequences for users a and b. Sector 2 would then blank the transmissions for its four users e through h whenever these transmissions interfere with users a and b. Similarly, sector 2 may have difficulty transmitting to user e. Since user e has sector 1 as the only non-serving sector in its active set, sector 2 informs sector 1 of the difficulty in transmitting to user e and also provides the FH sequence for user e. Sector 1 would then blank the transmissions for its four users a through d whenever these transmissions interfere with user e.

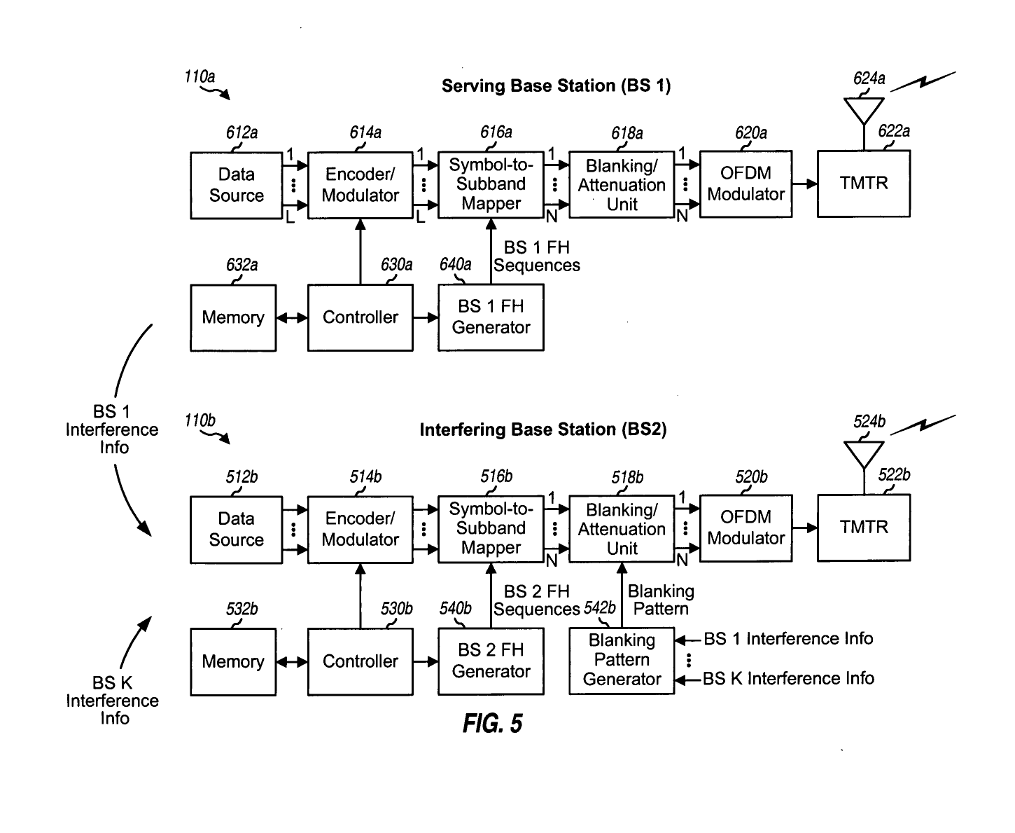

FIG. 5 shows a block diagram of an embodiment of serving base station 110a and interfering base station 110b for terminals in sector 1. For simplicity, only the transmitter portion of base stations 110a and 110b is shown in FIG. 5.

Within base station 110a, an encoder/modulator 614a receives traffic/packet data from a data source 612a for L users being served by base station 110a (where L≧1) and control/overhead data from a controller 630a. Encoder/modulator 614a processes (e.g., formats, encodes, interleaves, and modulates) the traffic/packet data for each user based on a coding and modulation scheme selected for that user and provides data symbols, which are modulation symbols for data. Each modulation symbol is a complex value for a specific point in a signal constellation corresponding to the modulation scheme used for that modulation symbol.

A symbol-to-subband mapping unit 616a receives the data symbols for all L users and provides these data symbols onto the proper subbands determined by the FH sequences assigned to these users, which are generated by an FH generator 640a. Mapping unit 616a also provides pilot symbols on subbands used for pilot transmission and a signal value of zero for each subband not used for pilot or data transmission. For each OFDM symbol period, mapping unit 616a provides N transmit symbols for the N total subbands, where each transmit symbol may be a data symbol, a pilot symbol, or a zero-signal value. A blanking/attenuation unit 618a receives the transmit symbols from mapping unit 616a and performs selective blanking/attenuation for base station 110a.

An OFDM modulator 620a receives N transmit symbols (one or more which may have been blanked/attenuated) for each OFDM symbol period and generates a corresponding OFDM symbol. OFDM modulator 620a typically includes an inverse fast Fourier transform (IFFT) unit and a cyclic prefix generator. For each OFDM symbol period, the IFFT unit transforms the N transmit symbols to the time domain using an N-point inverse FFT to obtain a “transformed” symbol that contains N time-domain chips. Each chip is a complex value to be transmitted in one chip period. The cyclic prefix generator then repeats a portion of each transformed symbol to form an OFDM symbol that contains N+C chips, where C is the number of chips being repeated. The repeated portion is often called a cyclic prefix and is used to combat inter-symbol interference (ISI) caused by frequency selective fading. An OFDM symbol period corresponds to the duration of one OFDM symbol, which is N+C chip periods. OFDM modulator 620a provides a stream of OFDM symbols. A transmitter unit (TMTR) 622a receives and processes (e.g., converts to analog, filters, amplifies, and frequency upconverts) the OFDM symbol stream to generate a modulated signal. The modulated signal is transmitted from an antenna 624a to the terminals in sector 1.

Base station 110b similarly processes traffic and control data for users being served by base station 110b. However, a symbol-to-subband mapping unit 616b provides data symbols for the users in sector 2 onto the proper subbands determined by the FH sequences assigned to these users and generated by an FH generator 640b.

Controllers 630a and 630b direct the operation at base stations 110a and 110b, respectively. Controllers 630a and 630b may each implement processes 500 and 550 to reduce interference generated by their base station on the forward link. Memory units 632a and 632b provide storage for program codes and data used by controllers 630a and 630b, respectively.

For selective blanking/attenuation, base station 110a determines interference information indicating the specific subbands for which reduced inter-sector interference from base station 110b is sought. This interference information is sent to base station 110b. Base station 110b may also receive interference information from other base stations. Within base station 110b, a blanking pattern generator 642b generates a blanking pattern for base station 110b based on the received interference information from all neighboring base stations. Generator 642b may generate FH sequences for each target user in each neighboring sector based on the received interference information and combine the FH sequences for all target users in all neighboring sectors to obtain the blanking pattern for base station 110b. A blanking/attenuation unit 618b receives the transmit symbols from mapping unit 616b and performs selective blanking/attenuation based on the blanking pattern provided by generator 642b. Unit 618b may blank/attenuate transmit symbols that are mapped to, and collide with, the subbands in the blanking pattern.

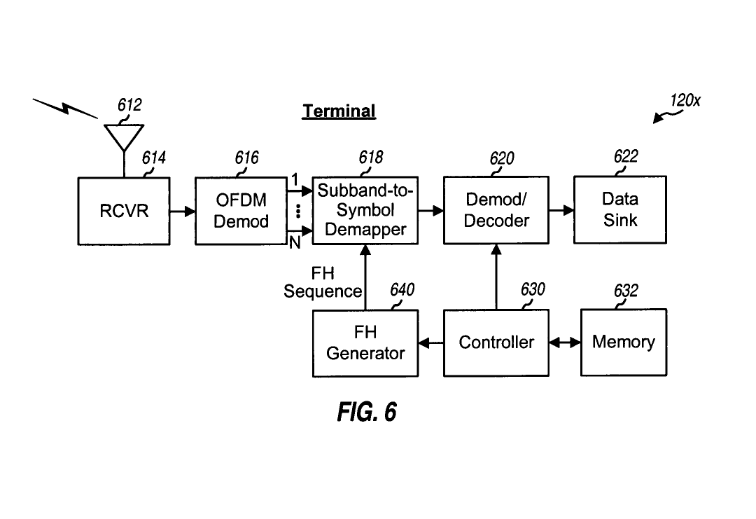

FIG. 6 shows a block diagram of an embodiment of a terminal 120x, which is one of the terminals in system 100. For simplicity, only the receiver portion of terminal 120x is shown in FIG. 6. The modulated signals transmitted by the base stations are received by an antenna 712, and the received signal is provided to and processed by a receiver unit (RCVR) 714 to obtain samples. The set of samples for one OFDM symbol period represents one received OFDM symbol. An OFDM demodulator (demod) 716 processes the samples and provides received symbols, which are noisy estimates of the transmit symbols sent by the base stations. OFDM demodulator 716 typically includes a cyclic prefix removal unit and an FFT unit. The cyclic prefix removal unit removes the cyclic prefix in each received OFDM symbol to obtain a received transformed symbol. The FFT unit transforms each received transformed symbol to the frequency domain with an N-point FFT to obtain N received symbols for the N subbands. A subband-to-symbol demapping unit 718 obtains the N received symbols for each OFDM symbol period and provides received symbols for the subbands assigned to terminal 120x. These subbands are determined by the FH sequence assigned to terminal 120x, which is generated by an FH generator 740. A demodulator/decoder 720 may receive a puncturing pattern and may puncture received symbols for the subbands in the serving base station's blanking pattern. In any case, demodulator/decoder 720 processes (e.g., demodulates, deinterleaves, and decodes) the received symbols for terminal 120x and provides decoded data to a data sink 722 for storage.

A controller 730 directs the operation at terminal 120x. A memory unit 732 provides storage for program codes and data used by controller 730. Controller 730 may implement process 550 to reduce interference generated by terminal 120x on the reverse link.

For clarity, interference control has been specifically described for the forward link. These techniques may also be used to control inter-sector interference on the reverse link. The serving sector for each user may determine whether that user is causing excessive interference on the reverse link. For each user deemed to be causing excessive interference, the serving sector may determine the subbands for which interference should be reduced and provide this interference information to the user. Each interfering user would receive interference information from its serving sector and perform blanking/attenuation of its transmissions on the subbands indicated by the interference information.

For example, referring to FIG. 1, users a and b in sector 1 have multiple sectors in their active sets and may be deemed to cause excessive interference to user e, which has sector 1 as a non-serving sector in its active set. Users a and b may be provided with the FH sequence for user e and may blank/attenuate transmissions on subbands that collide with the FH sequence for user e. Similarly, user e may be deemed to cause excessive interference to users a and b in sector 1, both of which have sector 2 as a non-serving sector in their active sets. User e may be provided with the FH sequences for users a and b and may blank/attenuate transmissions on subbands that collide with the FH sequences for users a and b.

The techniques described herein may be used for OFDM-based systems as well as FDMA and TDMA systems. The selective blanking/attenuation may be performed on transmission spans, where a transmission span may cover time and/or frequency dimensions. For an FDMA system, a transmission span may correspond to one or more frequency subbands in a given time period, and transmissions on frequency subbands with excessive interference may be selectively blanked/attenuated. For a TDMA system, a transmission span may correspond to a given time interval, and transmissions on time intervals with excessive interference may be selectively blanked/attenuated. For an OFDM-based (e.g., OFDMA) system, a transmission span may correspond to a set of one or more subbands in one or more OFDM symbol periods.

It would be apparent to those skilled in the art that the techniques described herein may be used in CDMA, Wideband CDMA (W-CDMA), High Speed Downlink Packet Access (HSDPA), and direct sequence CDMA (DS-CDMA) wireless communication systems.

The interference estimation techniques described herein may be implemented by various means. For example, these techniques may be implemented in hardware, software, or a combination thereof. For a hardware implementation, the processing units used to perform interference control may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, the interference control techniques may be implemented with modules (e.g., procedures, functions, and so on) that perform the functions described herein. The software codes may be stored in a memory unit (e.g., memory unit 632 in FIG. 6 or memory unit 732 in FIG. 7) and executed by a processor (e.g., controller 630 in FIG. 6 or controller 730 in FIG. 7). The memory unit may be implemented within the processor or external to the processor, in which case it can be communicatively coupled to the processor via various means as is known in the art.

It would be apparent to those skilled in the art that the same blanking techniques used for the forward link can also be used on the reverse link.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of interference estimation in a wireless communication system, comprising:
determining a desired level of accuracy in an interference estimate; and
determining a required number of blanks per subband set to achieve the desired level of accuracy.

2. The method of claim 1, wherein the interference estimate is
$${\hat{σ}}_{I}^{2} = \frac{1}{{N}_{B}} {\sum }_{i = 1}^{{N}_{B}} {\vert {n}_{i} \vert}^{2} , {n}_{i} \sim CN ( 0 , {σ}_{I}^{2} ) ,$$
where
σ_{I}^{\hat{ }2} is the interference estimate,
N_{B} is the number of blank pilots,
nᵢ is the observation on the i^{th} blank pilot, and
σ_{I}² is true variance.

3. The method of claim 1, further comprising inserting the required number of blanks per subband set into a frequency hopping (FH) sequence.

4. The method of claim 3, wherein the required number of blanks per subband are inserted into the FH sequence in a random manner.

5. The method of claim 3, further comprising transmitting according to the FH sequence.

6. The method of claim 5, wherein transmitting according to the FH sequence is implemented by reducing transmit power for the blanks.

7. The method of claim 6, wherein the wireless communication system utilizes orthogonal frequency division multiplexing (OFDM).

8. An apparatus operable to estimate interference in a wireless communication system, comprising:
a controller operative to create a fast hopping (FH) sequence including a required number of blanks per subband set; and
a unit operative to turn off or reduce transmit power for transmissions sent on a plurality of transmission spans according to the FH sequence.

9. The apparatus of claim, wherein the wireless communication system is an orthogonal frequency division multiple access (OFDMA) system.

10. An apparatus operable to estimate interference in a wireless communication system, comprising:
means for determining desired level of accuracy in an interference estimate; and
means for determining required number of blanks per subband set to achieve the desired level of accuracy.

11. The apparatus of claim 10, further comprising means for inserting the required number of blanks per subband set into a frequency hopping (FH) sequence.

12. The apparatus of claim 11, further comprising means for transmitting according to the FH sequence.

13. The apparatus of claim 12, wherein the wireless communication system utilizes orthogonal frequency division multiplexing (OFDM).

14. A computer readable media embodying a method for estimating interference caused by a transmitting entity in a wireless communication system, the method comprising:
determining a desired level of accuracy in an interference estimate; and
determining a required number of blanks per subband set to achieve the desired level of accuracy.

15. The computer readable media of claim 14, the method further comprising inserting the required number of blanks per subband set into a frequency hopping (FH) sequence.

16. The computer readable media of claim 15, the method further comprising transmitting according to the FH sequence.

17. The computer readable media of claim 16, wherein the wireless communication system utilizes orthogonal frequency division multiplexing (OFDM).

18. A processor programmed to execute a method of estimating interference in a wireless communication system, the method comprising:
determining a desired level of accuracy in an interference estimate; and
determining a required number of blanks per subband set to achieve the desired level of accuracy.
